(19) United States
(12) Patent Application Publication
(10) Pub. No.: US 2013/0072237 A1
(43) Pub. Date: Mar. 21, 2013

(54) VOICE CONTROLLED CELL PHONE

(71) Applicant: PRADEEP RAMDEO, Bronx, NY (US)

(72) Inventor: PRADEEP RAMDEO, Bronx, NY (US)

(21) Appl. No.: 13/234,142

(22) Filed: Sep. 15, 2011

(51) Int. Cl. H04W 4/12

(52) U.S. Cl. 455/466

(57) ABSTRACT

A hand-free voice controlled cell phone which includes an antenna, a transceiver coupled to the antenna, a processor coupled to the transceiver, a microphone coupled to the processor and a speaker coupled to the processor. A memory unit is within the processor. A first program within the memory unit is for converting a voice message from the microphone made by a person using the cell phone into a text message for deaf person. The processor can output the text message to the transceiver and out of the antenna, to allow another person using a remote second cell phone to receive the text message. The first program for converting the voice message into a text message includes a voice-to-text software.

### BACKGROUND OF THE INVENTION

1. Field of the Invention

The present invention relates to a wireless mobile communication device, and more particularly, a voice controlled cell phone. The voice control cell phone provides deaf people with a product that makes cellular phone use easier, safer, and more convenient than is possible with conventional smart phones. The present invention features several amenities that simplify smart phone applications for people who are disabled or have difficulty using regular cell phones. Special features, such as a voice-to-text software or similar type software, will convert spoken words of a person into a text message. It also includes a voice-recognition software or similar type software, as well as traditional smart phone applications, such as a camera/flash, video/audio recorder and music player.

2. Description of the Prior Art

Conventional cell phones can be difficult to operate. Texting, for example, can be a difficult task to perform if keypads are not user-friendly. People who have disabilities or certain physical limitations may find texting to be nearly impossible. People who have the ability to text, however, tend to do so frequently. Many people even text while driving, which increases the risk of serious or fatal car accidents. Cell phone use while driving is banned in many states to prevent such accidents from occurring. This is a safe but inconvenient solution, as people may need to take important calls or texts while in transit.

Numerous innovations for telecommunications technologies have been provided in the prior art that will be described. Even though these innovations may be suitable for the specific individual purposes to which they address, however, they differ from the present invention.

A FIRST EXAMPLE, U.S. Patent Office Publication No. 2004/0202291, published on Oct. 14, 2004, to Skinner teaches a wireless mobile phone having voice recording, and method of operating the mobile phone. In one embodiment, a method for handling a voice recording with a wireless mobile phone comprises recording and storing a voice signal as a voice recording into at least one of an internal memory and a removable memory unit of the wireless mobile phone, and then electronically transferring the voice recording from the wireless mobile phone to an external target device.

A SECOND EXAMPLE, U.S. Pat. No. 7,792,678, issued on Sep. 7, 2010, to Hung teaches a device that includes an image capturing device having a speech recognition device and a receiving device. The speech recognition device includes a voice command unit stored a plurality of voice commands, a voice character memory unit stored a plurality of voice characteristics corresponding to the voice commands for indentifying the commands conforming to the voice characteristics received in the receiving device to form a voice command set, and an image characteristic memory unit stored a plurality of image characteristics corresponding to the voice commands of the voice command set. The image capturing device captures a real-time image to compare with the image characteristic in the image characteristic memory unit. The image capturing device selects a command from the command set and executes the selected command according to the comparing result generated by the image capturing device.

A THIRD EXAMPLE, U.S. Patent Office Publication No. 20100323657, published on Dec. 23, 2010, to Barnard et al. teaches a method, system, and media directed to managing a mobile communications device. In one embodiment, a communication event and spatial state for the mobile device is received. If the event is at least one of a plurality of preselected types and the spatial state of the device satisfies a preselected condition, the communication event is call-processed while initiating a notification of the event to a user of the mobile device.

A FOURTH EXAMPLE, U.S. Pat. No. 7,869,800, issued on Jan. 11, 2011, to Netanel et al. teaches a portable cellular phone system, wherein matched sets of algorithmically generated communication units are generated, each defining an increment of authorized communication. One set is stored on a system server, i.e. a service provider, and the pre-paid set is available for use within a portable cellular phone. The portable cellular phone, which is normally non-activated, automatically contacts the system server upon selective activation by the user, to initiate a call (outgoing or incoming). A voice recognition system allows the user to place calls and/or receive calls. During a call, the portable cellular phone and the system server allow authorized access to communication, while the communication units are decremented at the system server and at the portable cellular phone. The portable cellular phone typically has either an internal energy supply and storage for the pre-paid communication units, or a removable airtime cartridge, typically containing an energy supply and either the ability to store or to generate a set of pre-paid single use airtime communication units.

A FIFTH EXAMPLE, U.S. Patent Office Publication No. 2011/0166860, published on Jul. 7, 2011, to Tran teaches systems and methods to operate a mobile device by capturing user input; transmitting the user input over a wireless channel to an engine, analyzing at the engine music clip or video in a multimedia data stream and sending an analysis wirelessly to the mobile device.

It is apparent now that numerous innovations for telecommunications technologies have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a voice controlled cell phone that avoids the disadvantages of the prior art.

ANOTHER OBJECT of the present invention is to provide a voice controlled cell phone that is simple and inexpensive to manufacture.

STILL ANOTHER OBJECT of the present invention is to provide a voice controlled cell phone that is simple to use.

BRIEFLY STATED, STILL YET ANOTHER OBJECT of the present invention is to provide a voice controlled cell phone which comprises an antenna, a transceiver coupled to the antenna, a processor coupled to the transceiver, a microphone coupled to the processor and a speaker coupled to the processor. A memory unit is within the processor. A first program within the memory unit is for converting a voice message from the microphone made by a person using the cell phone into a text message. The processor can output the text message to the transceiver and out of the antenna, to allow another person using a remote second cell phone to receive the text message. The first program for converting the voice message into a text message comprises a voice-to-text software or similar type software.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a block diagram of the present invention showing various components therein;

FIG. 2 is a perspective view showing a person in a motor vehicle converting a voice message into a text message using the present invention;

FIG. 3 is a perspective view showing another person using a remote cell phone to read the text message;

FIG. 4 is a perspective view showing a person using the present invention hands free while driving; and

FIG. 5 is a perspective view showing the present invention in a wireless charging cradle.

### REFERENCE NUMERALS UTILIZED IN THE DRAWING

110 voice controlled cell phone
112 antenna of cell phone 110
114 transceiver of cell phone 110
116 processor of cell phone 110
118 microphone of cell phone 110
120 speaker of cell phone 110
122 memory unit in processor 116
124 first program within memory unit 122
126 person using cell phone 110
128 person using remote second cell phone 130
130 remote second cell phone
132 voice-to-text software for first program 124
134 second program within memory unit 122
136 text-to-voice software for second program 134
138 third program within memory unit 122
140 voice-recognition software for third program 138
142 wireless charging cradle for cell phone 110
144 rechargeable battery in cell phone 110
146 screen in cell phone 110
148 keypad in cell phone 110
150 Global Positioning System in cell phone 110
152 control buttons in cell phone 110
154 USB port in cell phone 110
156 camera in cell phone 110
158 vibration device in cell phone 110

### DETAILED DESCRIPTION OF THE PREFERRED EMBODIMENT

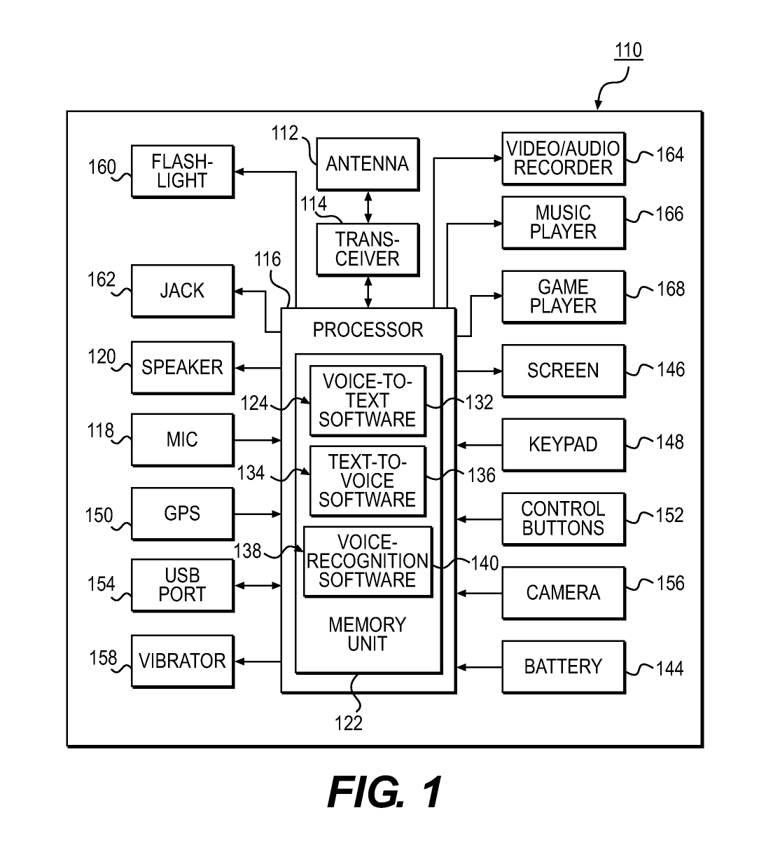

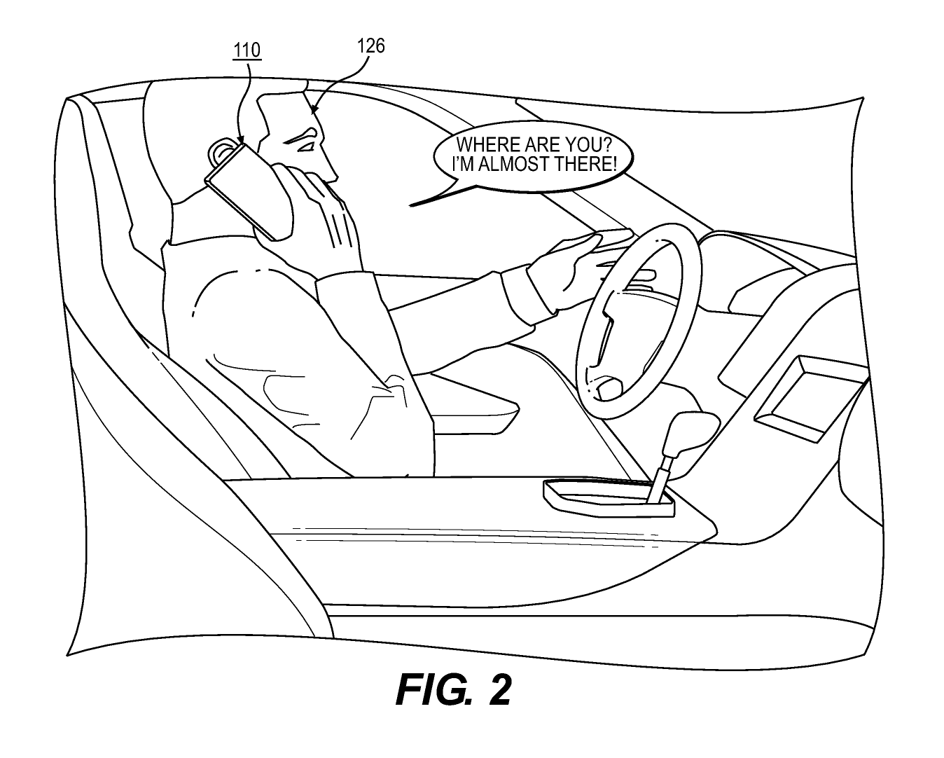

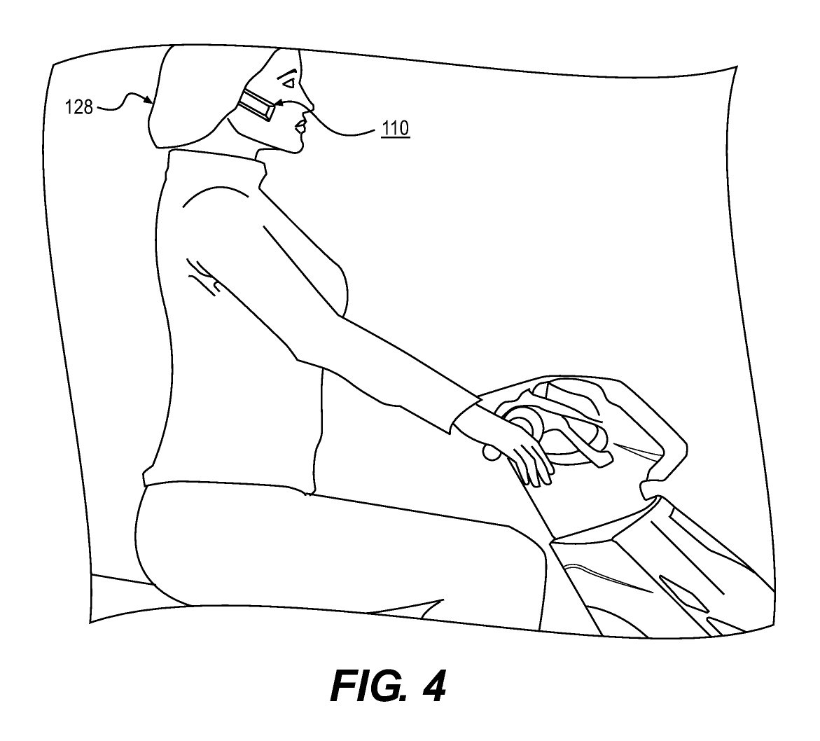

FIG. 1 shows the present invention being a voice controlled cell phone 110 which comprises an antenna 112, a transceiver 114 coupled to the antenna 112, a processor 116 coupled to the transceiver 114, a microphone 118 coupled to the processor 116 and a speaker 120 coupled to the processor 118. A memory unit 122 is within the processor 116. A first program 124 within the memory unit 122 is for converting a voice message from the microphone 118 made by a person 126 using the cell phone 110 into a text message, shown in FIGS. 2 and 4. The first program 124 for converting the voice message into a text message comprises a voice-to-text software 132.

A second program 134 within the memory unit 122 is for converting an inbound text message received by the transceiver 114 from the antenna 112 into a voice message. The processor 116 can output the voice message into the speaker 120 to allow the person 126 using the cell phone 110 to hear the voice message. The second program 134 for converting the inbound text message into a voice message comprises a text-to-voice software 136. A third program 138 within the memory unit 122 is for recognizing a voice of the person 126 using the cell phone 110, whereby the processor 116 will allow the person 126 to perform various traditional voice command tasks on the cell phone 110. The third program 138 for recognizing the voice of the person using the cell phone 110 comprises a voice-recognition software 140.

In review, FIG. 1 shows all the different elements of phone 110. The antenna 112 is connected to the transceiver 114 and routes inbound calls (e.g., voice signals and text) to the processor 116. The processor 116 also sends outbound calls that were initiated by the person 126 to the transceiver 114 where the call is broadcast over the antenna 112. The processor 116 is not limited to a single processor, but can also comprise two or more processors that are able to communicate with each other. The memory unit 122 in the processor 116 is responsible for programming, processing and handling any and all of the features and functions of the cell phone 110. The memory unit 122 comprises the first program 124 being the voice-to-text software 132, the second program 134 being the text-to-voice software 136 and the third program 138 being the voice recognition software 140. The processor 116 is also connected to other components associated with the cell phone 110 and includes the speaker 120, a screen 146, the microphone 118, a keypad 148, a Global Positioning System 150, control buttons 152, a USB port 154, a camera 156, a vibration device 158, a flashlight 160, a headphone jack 162, a video/audio player 164, a music player 166 and a game player 168.

The processor 116 may be any programmable microprocessor, microcomputer or multiple processor chip or chips that can be configured by software instructions (applications) to perform a variety of functions, including the functions of the various embodiments described herein. In some cell phones, multiple processors may be provided, such as one processor dedicated to wireless communication functions and one processor dedicated to running other applications.

The voice control cell phone 110 is a smart phone with modifications that allow people to use its various applications with ease. Various models may have different features including hardware, software and etc. Some models may be designed for people with certain specific disabilities such as for example blind or the hearing impaired [deaf]. The present invention contains the touch screen 146 and many traditional applications, such as hands-free capabilities including internet accessibility, the game player 168, camera 156, and other similar features. The headphone jack 162 and volume control buttons 152 may be located on one side of the cell phone 110, while the control buttons 152 for the camera 156 and music player 166 can be included on the opposite side. The top of the cell phone 110 can include the flashlight 160 with a power button. In terms of innovative, non-traditional functions, the cell phone 110 has a voice-to-text software 132 or similar type software. This software 132 can allow the person 126 to speak while the cell phone 110 converts the spoken words into a text message. The voice-recognition software 140 or similar type software may also be utilized during this process, and can be used to perform traditional voice-command tasks. The text-to-voice software 136 can also convert incoming texts, allowing the cell phone 110 to speak the text message aloud.

As shown in FIG. 2, a person 126 (driving a vehicle) uses the cell phone 110 (with a first program 124 within the memory unit 122) for converting a voice message from the microphone 118 into a text message (also shown in FIG. 1).

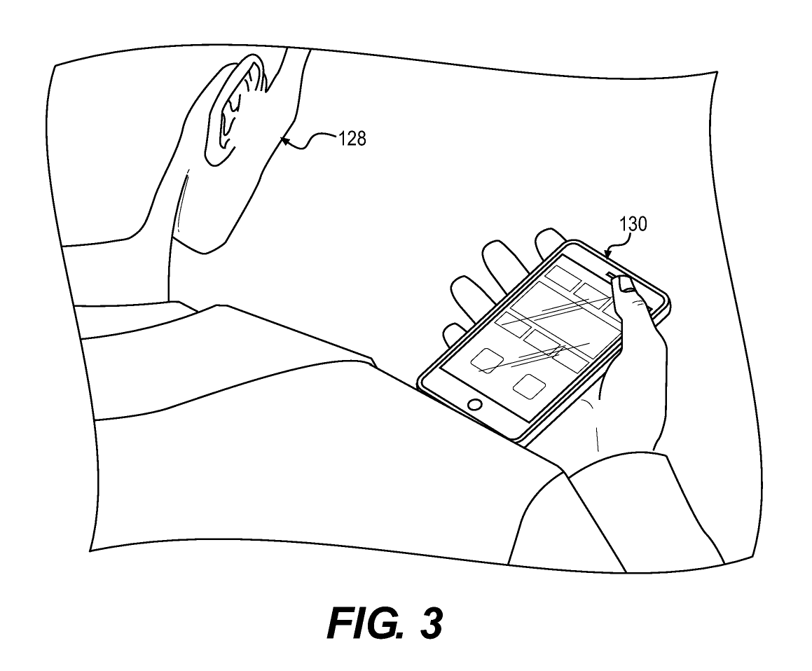

As shown in FIG. 3, the processor 116 can output the text message to the transceiver 114 and out of the antenna 112 to allow another person 128 using a remote second cell phone 130 to receive the text message (also shown in FIG. 1).

As shown in FIG. 4, a person 126 (riding a motorbike) uses the cell phone 110 (with a first program 124 within the memory unit 122) for converting a voice message from the microphone 118 into a text message.

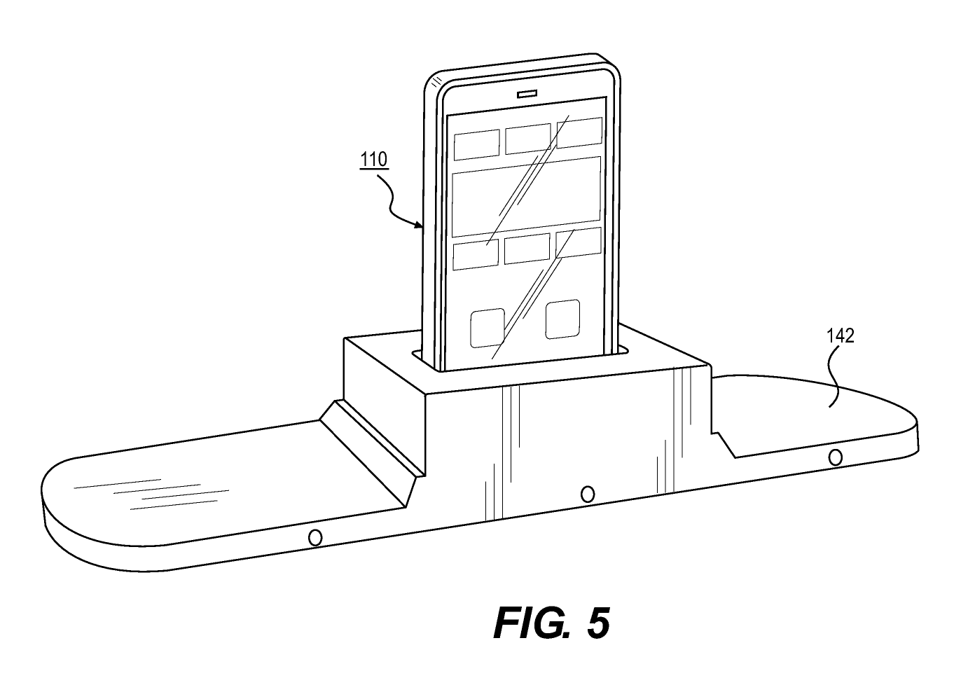

As shown in FIG. 5, the cell phone 110 further comprises a wireless charging cradle 142 that is compatible with the cell phone 110, whereby the cradle 142 can supply power to a rechargeable battery 144 within the cell phone 110 in FIG. 1. The cell phone 110 may be charged wired. The wireless charging cradle 142 will supply power to the rechargeable battery 144. The present invention can be used for convenience by any person, and is ideal for assisting elderly or disabled persons to utilize all of their phone applications with ease. The exact specifications may vary.

It will be understood that each of the elements described above, or two or more together, may also find a useful application in other types of constructions differing from the types described above.

While the invention has been illustrated and described as embodiments of a voice controlled cell phone, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A hand-free voice controlled cell phone for deaf person which comprises:
a) an antenna;
b) a transceiver coupled to the antenna;
c) a processor coupled to the transceiver;
d) a microphone coupled to the processor;
e) a speaker coupled to the processor;
f) a touchscreen coupled to the processor for displaying;
g) a memory unit within the processor; and
h) means within the memory unit for converting an incoming voice message from the microphone made by a person using the cell phone into an inbound text message on the touchscreen for deaf person, whereby the processor can output different outbound text message of the deaf person to the transceiver and out of the antenna to allow another person using a remote second cell phone to receive the outbound text message.

2. The cell phone as recited in claim 1, wherein the means for converting the incoming voice message into the inbound text message for the deaf person comprises a voice-to-text software.

3. The cell phone as recited in claim 1, further comprising means within the memory unit for converting a text message received by the transceiver from the antenna into a voice message for blind person, whereby the processor can output the voice message into the speaker to allow the blind person using the cell phone to hear the voice message.

4. The cell phone as recited in claim 3, wherein the means for converting the inbound text message into a voice message comprises a text-to-voice software.

5. The cell phone as recited in claim 1, further comprising means within the memory unit for recognizing a voice of the person using the cell phone, whereby the processor will allow the person to perform various traditional voice command tasks on the cell phone such as music playing, video/audio recording, game playing, photographing and navigation.

6. The cell phone as recited in claim 5, wherein the means for recognizing the voice of the person using the cell phone comprises a voice-recognition software.

7. The cell phone as recited in claim 1, further comprising a wireless charging cradle that is compatible with the cell phone, whereby the cradle can supply power to a rechargeable battery within the cell phone.
